(19) United States
(12) Patent Application Publication
(10) Pub. No.: US 2009/0056887 A1
(43) Pub. Date: Mar. 5, 2009

(54) PRIVACY SCREEN ENCLOSURE

(76) Inventor: Matt Britt, Chico, CA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 12/198,285

(22) Filed: Aug. 26, 2008

Related U.S. Application Data
(60) Provisional application No. 60/968,127, filed on Aug. 27, 2007.

(51) Int. Cl. E06B 3/00

(52) U.S. Cl. 160/368.1

(57) ABSTRACT

The disclosure encompasses a privacy barrier (curtain) to be temporarily attached to a vehicle without requiring any substantial modification to the vehicle. This privacy barrier mounts to a vehicle and spans the gap formed between an open door and the body of the vehicle, or alternatively between a plurality of open doors. These can be side doors, or rear doors. The fasteners used to attach the curtain to the vehicle can be clips, magnets, suction cups, or similar devices that can be attached to, and removed from, the vehicle without any substantial modification to the vehicle. The disclosure may utilize fasteners having a non-marring surface or an intermediate, non-marring material between the fastener and the vehicle.

### RELATED APPLICATIONS

This application claims priority benefit of U.S. Ser. No. 60/968,127, filed Aug. 27, 2007.

### BACKGROUND OF THE DISCLOSURE

### a) Field of the Disclosure

The disclosure encompasses a privacy barrier (curtain) to be temporarily attached to a vehicle without requiring any modification to the vehicle. This privacy barrier temporarily and removably affixes to a vehicle. One intended use for a user who wishes a small privacy area for example to change clothes in where a more suitable facility is not convenient.

### SUMMARY OF THE DISCLOSURE

The disclosure encompasses a privacy barrier (curtain) to be temporarily attached to a vehicle without requiring any substantial modification to the vehicle. This privacy barrier mounts to a vehicle and spans the gap formed between an open door and the body of the vehicle, or alternatively between a plurality of open doors. These can be side doors, or rear doors. The fasteners used to attach the curtain to the vehicle can be clips, magnets, suction cups, or similar devices that can be attached to, and removed from, the vehicle without any substantial modification to the vehicle. The disclosure may also utilize fasteners having a non-marring surface or an intermediate, non-marring material between the fastener and the vehicle. This disclosure is a device and method for a privacy screen that is easy to erect, time saving, lightweight, and compact. The device conforms to substantially all vehicles and in one embodiment has no rigid stays which would hinder storage and setup. The resulting device can be manufactured at a very low cost using established processes.

### BRIEF DESCRIPTION OF THE DRAWINGS

FIG. 1 is an isometric view, generally from the top, of one embodiment of the privacy curtain attached to a two-door vehicle.

FIG. 1a is a top view, of one embodiment of the privacy curtain attached to a two-door vehicle.

FIG. 1b is an isometric view, generally from the top, of another embodiment of the privacy curtain attached to a two-door vehicle.

FIG. 2 is an isometric view, generally from the top, of one embodiment of the privacy curtain attached to a four-door vehicle.

FIG. 2a is a top view, of one embodiment of the privacy curtain attached to a four-door vehicle.

FIG. 3 is a side cutaway view of one embodiment of a fastener attached to a material sheet.

### DESCRIPTION OF THE PREFERRED EMBODIMENTS

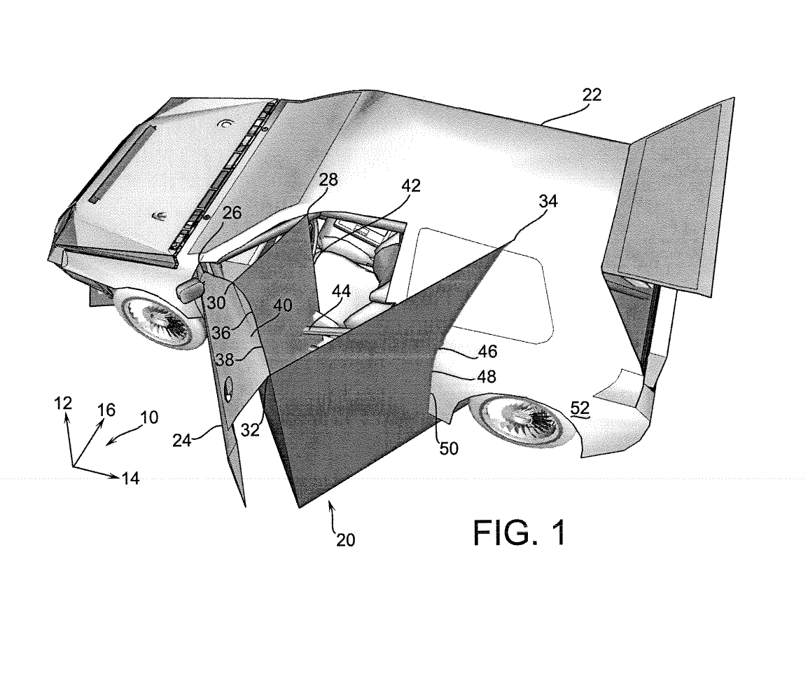

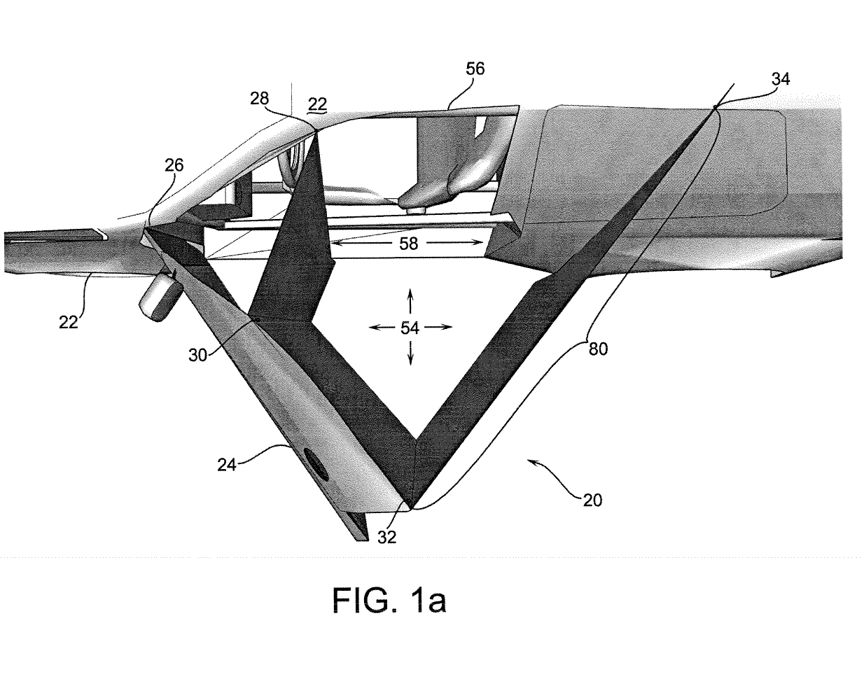

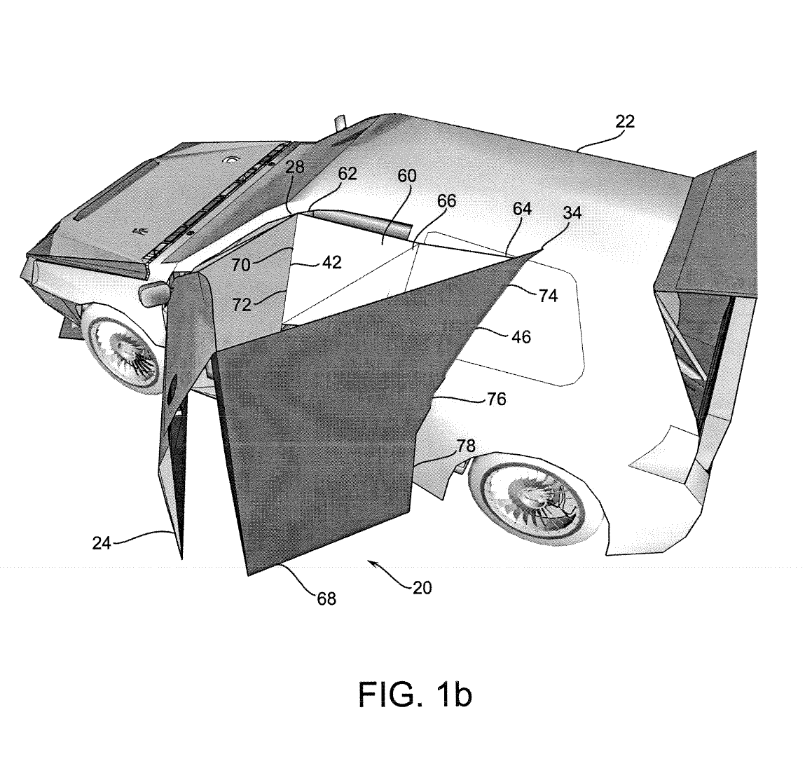

Before beginning, and axes system 10 is disclosed, including a vertical axis 12, a longitudinal axis 14, and a transverse axis 16. These axes can be seen in FIG. 1 and generally describe directions for ease of understanding. It is understood, of course, that the embodiments can be repositioned into other orientations to fit alternative applications.

It is often desired for a user to have a small, temporary privacy area near their vehicle, which could then be dismantled and stored conveniently within the vehicle taking up a very small amount of the interior portion of the vehicle. Such privacy areas are useful, for example, during sailing regattas, kayaking, wind surfing, biking, skiing triathlons, or while surf entry diving. A user engaged in these activities may drive to a location, change from their street clothes to a swimsuit and/or wet suit, engage in recreation, then change back to their street clothes prior to leaving. Oftentimes, restroom or changing facilities are not close, or are possibly unavailable, or undesirable.

The device in one form is also very useful to emergency service personnel, FEMA personnel, and Red Cross personnel. Where extrication of a passenger or driver is not possible, the apparatus can be set up and attached to the vehicle blocking the view of occupants or contents of the vehicle from passersby. This will make it easier for emergency service personnel to do their job, and will real relieve some of the anxiety on the part of the occupants of the vehicle. Thus, a quick and efficient means for forming a privacy area is desired.

Prior art attempts to satisfy this need, such as found in U.S. Pat. Nos. 2,066,078, 2,122,668 and others, for an enclosed area often require rigid stays, straps, ropes, etc. Alternatively, or additionally, relatively permanent adaptations to the vehicle were required, such as embodied in U.S. Pat. Nos. 2,532,989 and 6,044,856. In these, and similar examples, a portion of the attachment system is permanently attached to the vehicle. This substantially, and often negatively, reduces the perceived value and aesthetics of the vehicle. Many of these examples had very negative effects in that the privacy screen could not be easily stored, say, for example, in a vehicle glove compartment or door pouch. While, in the past, it was not considered disadvantageous to make modifications to a vehicle; this is not the case today. Most people do not desire permanent adaptations to their vehicles, as shown by the wide variety of roof racks and bicycle carriers which can be fixedly and removably attached to a vehicle, and do not require substantial nor permanent modification to the vehicle.

Many similar prior art devices were formed to function also as protection from wind, rain, sun, etc., thus, having a roof and/or a floor. This configuration (including a roof/floor) made set up and take down much more difficult than the disclosed embodiments. In some examples, a vertical extension is required in prior art devices to attain the height needed for proper headroom. These embodiments are larger, and thus, require more space to store. These embodiments often did not provide privacy to the region between the occupant and the open doorway.

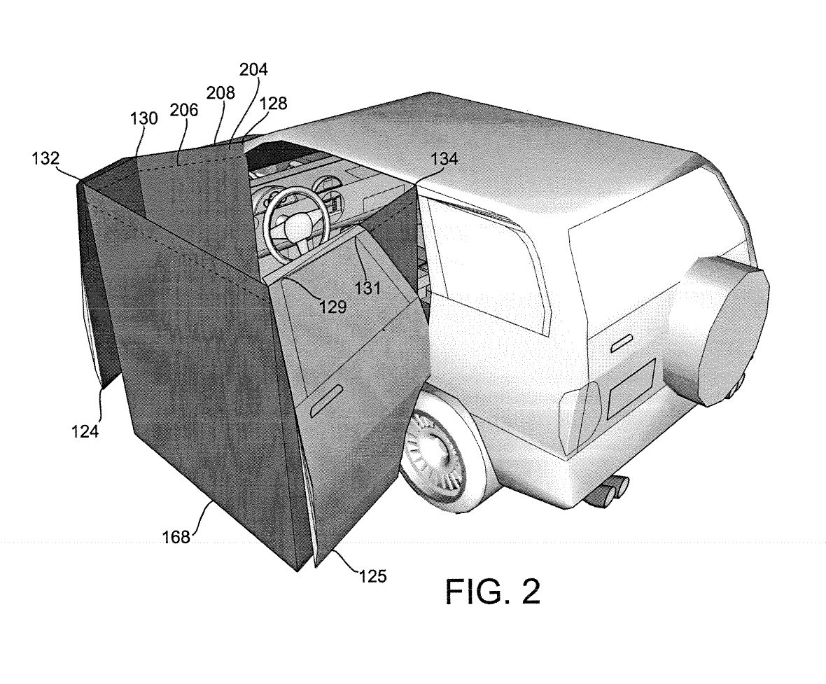

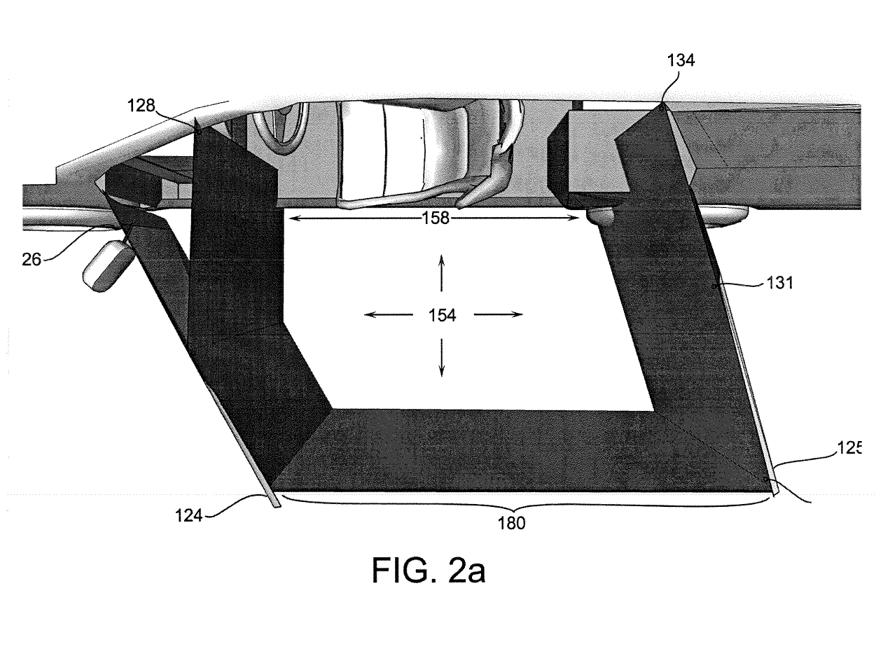

In the embodiments shown in FIGS. 1, 1a, and 1b, a material sheet 68 forms a curtain 20 which is shown attached to a vehicle 22 having a single side opening door 24. This embodiment of the curtain could easily be adaptable to a similar vehicle having a plurality of side opening doors 24, wherein the foreword portion 26 of each door is hingedly coupled to the vehicle 22. An alternate embodiment is shown in FIGS. 2 and 2a attached to a vehicle 122 having a plurality of side opening doors, and including a front door 124 and a rear door 125. This second embodiment will be described in more detail after a full description of the first embodiment.

It will be noted that for the curtain to be effective, a non-transparent material should be used. While the material need not be opaque, the material should not be transparent to the point that any substantial details can be seen through the curtain. It may be useful to have areas of varying non-transparency. For example, it may not be needed to have the portion of the curtain adjacent an opaque portion of the vehicle, or below knee level, or above shoulder level comprised of a non-transparent material. Thus, these areas could be made from screen, clear plastic sheet, or other materials different from the remainder of the curtain 20.

In one embodiment, the curtain does not rely on any rigid or flexible stays. This will increase the ease of set-up, and will substantially reduce the stored volume of the enclosure. For example, the enclosure can be formed of lightweight rip-stop nylon, providing for a stored volume on the order of 100 cubic inches. In one embodiment, the entire stored curtain can fit within a volume of 3″×3″×10″ or possibly as little as 5″×5″×2″ when produced of very thin material. This would fit easily within a glove box, or other small storage area.

### Description of First Embodiment

Returning to FIG. 1, it can be seen how the curtain 20 is attached to the vehicle 22 at a plurality of points. While the attachment fasteners shown generally allow for a variety of fastening points, in this example, the curtain 20 is attached at a first attachment point 28, a second attachment point 30, a third attachment point 32, and a fourth attachment point 34. Other attachment points could be utilized, such as a plurality of points 36 and 38 at the upper portion 40 of the door 24 to further secure the curtain. Additionally, a plurality of attachment points along the forward edge 42 of the curtain 20 could hold the curtain 20 in position, such as at the door well, as shown as attachment point 40. Similarly, fasteners, and thus, attachment points could be coupled at the rearward edge, for example, at attachment points 48 and 50 to the rear quarter panel 52, or another location. Thus, as shown in FIG. 1a, the gap 80 between the outermost edge of the open door and the body of the vehicle is bridged substantially enhancing the privacy of an occupant within the privacy area 54.

Positioning this curtain, as shown in FIG. 1A, provides a partial privacy area 54. As you can see, the curtain 20 in this example has an open area 58 towards the vehicle 22 through the open doorway 56. This may be desirable as a compromise between ease of setup, privacy, and access to the interior portion (driver's seat) of the vehicle 22.

If it is desired to close off this area 58, another material sheet 60 may be positioned, for example, between the attachment point 28 near the front part of the door and the attachment point 34 near the rear portion of the doorway, as shown in FIG. 1B. This material sheet 60 could attach to the vehicle at a forward attachment point 62, a rearward attachment point 64 and at least one intermediate point 66. It is also conceived wherein the first material sheet 68 attaches to the second material sheet 60 along a vertical edge, such as the forward edge 42 at attachment points 70, 72, etc., and also along the rearward edge 46 at attachment points 74, 76 and 78. This can be accomplished either by Velcro, snaps, clips, interoperating magnets, or any similar removable fastening system. In addition, in one embodiment the first material sheet 68 and second material sheet 60 could be formed as a unitary structure. This embodiment substantially provides 360° of privacy in a horizontal plane around a user. Where the edges of the first and second material sheet come together, access to the interior portion of the vehicle can be achieved. The material sheets can also be oriented to allow an opening for entrance and egress to the privacy area. It may also be desirable to have an opening such as a zippered window, a Velcro seam, or simply a split down a portion of this second material sheet 60 to allow easy access to the interior portion of the vehicle and still allow for privacy. It may also be desirable to have the second material sheet 60 be a separate, smaller apparatus than the first material sheet 68 such that the overall apparatus folds into a smaller area and is easier to set up and take down.

In some vehicles having a rear door or doors, the embodiments shown above can be used upon those doors in a very similar manner.

### Description of Second Embodiment

Looking to the embodiment shown in FIGS. 2 and 2A, it can be seen that many of the same methods and apparatus are utilized. For example, the material sheet 168 can be very similar to the material sheet 68, except in one embodiment being longer in the longitudinal 14 and vertical 12 directions. To ease in understanding, the same numbering is generally used, being incremented by 100. One similarity between this example and the previous embodiment is that the material sheet 168 is attached at a forward attachment point 128, a second attachment point 130, a third attachment point 132, and a fourth attachment point 134. In addition, the material sheet 168 can be attached to the open rear door 125, for example, at attachment points 129 and 131. This allows for a much larger privacy area 154, as seen in FIG. 2A. Of course, once again a second material sheet 60 could be placed in the open area 158 to substantially enclose the privacy area 154 on all vertical sides. This can be facilitated by interoperating magnets provided on the vertical edges 128 and 134 of each material sheet. This can form a privacy curtain substantially surrounding the privacy areas on all horizontal sides, in one embodiment leaving the top and bottom sides open. Alternatively, as previously discussed, this open area 158 could remain uncovered to allow access to the interior portion of the vehicle.

Thus, the gap 180 between the outermost edge of the open door and the body of the vehicle is bridged substantially enhancing the privacy of an occupant within the privacy area 154. This embodiment substantially provides 360° of privacy in a horizontal plane around a user.

In some vehicles having a rear door or doors, the embodiments shown above can be used upon those doors in a very similar manner.

### Description of Several Embodiments of Fasteners

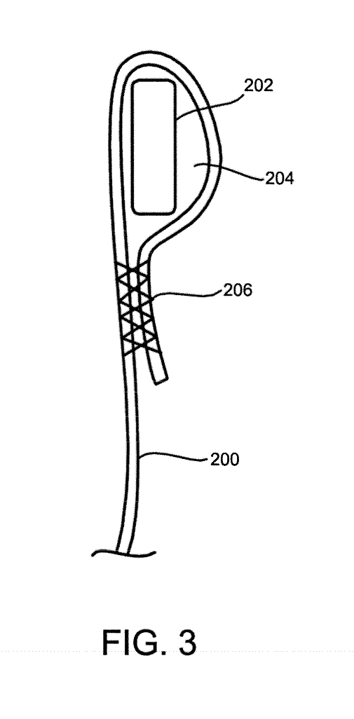

One preferred method for attaching the material sheets to the vehicle utilizes a plurality of magnetic fasteners. For example, as shown in FIG. 3, a material sheet 200 is folded around a magnet 202 forming a loop or pocket 204 into which the magnet 202 is disposed. The fabric is then stitched 206 or otherwise attached which encloses the magnet 202.

This stitching 206 can also be seen in FIG. 2 as a substantial sleeve around the upper portion of the material sheet 168. In one embodiment, this allows for transverse and longitudinal repositioning of the magnets 202. Alternatively, vertical stitching 208, as shown in FIG. 2, could be included to partially or substantially prohibit transverse and longitudinal repositioning of the magnets 202 within the pocket 204.

In one example, the material sheets forming the curtain 20 could be produced from a lightweight synthetic material commonly known as rip-stop nylon. Alternatively, other woven or non-woven fabrics and materials could be utilized including canvas, Tyvec®, or a lightweight plastic sheet. There are many materials which could be utilized to achieve this objective as long as the material allows for folding, or stuffing the curtain 20 into a very small space such as, for example, a vehicle glove compartment, door pocket, seat pocket, etc., to allow for easy storage and transportation.

In addition, a plurality of markers could be utilized such as paint dabs, a removable sticker, or similar elements to more permanently indicate upon the vehicle a preferred positioning of the fastener. This may make set up easier, and quicker.

In addition, a plurality of fastening systems could be utilized at the same time. For example, in a vehicle having frameless doors, it may be desirable to have a portion of the curtain attach to the vehicle by way of magnets coupled to the body of the vehicle. In addition, a portion of the curtain may be attached to the window on the door by way of a clip or suction cup. The suction cups or clips could include a portion configured to interoperate with magnets as previously described.

In addition, the curtain can be attached to a vehicle having frameless windows on the doors, by attaching the first end of the curtain to the body of the vehicle substantially forward of the open doorway, positioning the curtain around the exterior or interior of the open door, and attaching the second end of the curtain to the body of the vehicle. Thus where the curtain is positioned exterior of the door, frictional and static forces will help keep the curtain positioned. Where the curtain is positioned interior or exterior of the door, a portion of the curtain may be “folded over” the top edge of the window or door and thus further held in place. The downward force of the top edge of the curtain, including any fasteners such as magnets disposed in this upper edge, will increase the ability of the curtain to remain in place without putting undue pressure on the glass, nor requiring any permanent nor damaging fasteners to the window.

Of course, the fasteners can be attached to the interior, or the exterior portions of the door and/or vehicle.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A curtain to provide privacy to a user adjacent a vehicle, the curtain comprising:
a. a first non-transparent material sheet having an upper edge, a lower edge, a forward edge, and a rearward edge;
b. a plurality of non-marring fasteners connected to the upper edge of the first material sheet configured to removably attach to the vehicle;
c. wherein the material sheet forms at least a partial non-transparent barrier, substantially open on the top and the bottom when affixed to the vehicle;
d. the non-transparent barrier enclosing the space substantially defined on one side by the upper outer edge and lower outer edge of an open door of the vehicle and either the upper and lower edges of the doorway, or the upper and lower edges of a second open door of the vehicle;
e. the non-transparent barrier also covering any windows in the open doorways to which the curtain is attached;
f. wherein the material sheet comprises a pliable, foldable material; and,
g. the curtain operatively configured to attach to vehicles having different doorway configurations without modification to the material sheet.

2. The curtain of claim 1, wherein the non-marring fasteners are selected from the group consisting of magnets, suction cups, and clips.

3. The curtain of claim 2, wherein the non-marring fasteners comprise a plurality of magnets fixed within a sleeve in the upper edge of the material sheet,.

4. The curtain of claim 1, wherein the curtain is operatively configured to remain in position and form a non-transparent privacy barrier without any rigid stays.

5. The curtain of claim 1, further comprising a second material sheet having a top, bottom, forward and rearward edge.

6. The curtain of claim 1, wherein the curtain is configured to fixedly and removably couple to:
a. the body of the vehicle substantially at a forward portion of the doorway;
b. a portion of the open door; and
c. the body of the vehicle substantially a rearward portion of the doorway.

7. The curtain of claim 5, wherein the second material sheet is substantially smaller than the first material sheet.

8. The curtain of claim 5, further comprising a plurality of non-marring fasteners fixedly and removably coupled to at least one of the forward and/or rearward edge of at least one of the first material sheet and second material sheet.

9. The curtain of claim 8, wherein the first material sheet is visually distinguishable from the second material sheet.

10. The curtain of claim 1, wherein the material sheet is comprised of a woven material.

11. A method to position a non-transparent fabric curtain having a forward edge, a rearward edge, a top edge and a bottom edge, the curtain when in place providing privacy to a user adjacent to a vehicle having doors comprising the steps of:
a. opening at least one vehicle door;
b. identifying a plurality of anchor points on the vehicle comprising at least a first and a second anchor point, wherein at least one of the first and second anchor point is on the door of the vehicle;
c. fixedly and removably fastening the upper edge of the curtain to a first anchor point of the vehicle;
d. positioning a portion of the curtain fabric towards a second anchor point, such that a portion of the curtain bridges the gap formed between the open door and another portion of the vehicle;
e. fixedly and removably fastening a substantial portion of the top edge of the remaining portion of the curtain to the body of the vehicle, forming a non-transparent barrier;
f. wherein the non-transparent barrier encloses the space defined on one side by the upper outer edge and lower outer edge of an open door of the vehicle and either the upper and lower edges of the doorway, or the upper and lower edges of a second open door of the vehicle; and,
g. wherein the non-transparent barrier also substantially covers any windows in the open doors to which the curtain is attached.

12. The method as recited in claim 11, further comprising the step of fastening the rearward and/or forward edge of the curtain to the vehicle.

13. The method as recited in claim 11, wherein the curtain bridges the open space between a first open door of the vehicle and a second open door of the vehicle.

14. The method as recited in claim 11, further comprising the steps of:
a. providing a second curtain having a top edge; and,
b. fastening the top edge of the second curtain creating a non-transparent wall between a portion of the first curtain and the body of the vehicle.

15. A kit for providing limited privacy adjacent a vehicle comprising:
a. a first non-transparent material sheet;
b. a plurality of fasteners wherein the fasteners are configured to be non-marring fasteners;
c. instructions on setting up the curtain;
d. a second non-transparent material sheet;
e. a plurality of fasteners configured to interoperate with the second material sheet; and,
f. a bag or carrying device configured to hold all other elements of the kit.

16. The kit as recited in claim 15, wherein the first and the second material sheets are formed of rip-stop nylon fabric.

17. The kit as recited in claim 15, wherein the fasteners are selected from the group consisting of magnets, clips, and suction cups.

18. The kit as recited in claim 15, wherein the fasteners are magnets disposed within a portion of the first and the second material sheet.
